(19) United States
(12) Patent Application Publication
(10) Pub. No.: US 2010/0306851 A1
(43) Pub. Date: Dec. 2, 2010

(54) METHOD AND APPARATUS FOR PREVENTING A VULNERABILITY OF A WEB BROWSER FROM BEING EXPLOITED

(76) Inventor: Jun Zhou, Beijing (CN)

Correspondence Address: JENKINS, WILSON, TAYLOR & HUNT, P. A., 3100 Tower Blvd., Suite 1200, DURHAM, NC, 27707, US

(21) Appl. No.: 12/738,037

(22) PCT Filed: Oct. 15, 2008
(86) PCT No.: PCT/CN08/72699

§ 371 Date: Aug. 13, 2010

(30) Foreign Application Priority Data
Oct. 15, 2007 (CN) 200710162443.0

(51) Int. Cl. G06F 21/00

(52) U.S. Cl. 726/25

(57) ABSTRACT

A method and an apparatus for preventing a vulnerability of a web browser from being exploited are disclosed. The method comprises: monitoring a file downloaded by a browser process; intercepting a process creating action initiated by the browser process; determining whether the intercepted process creating action is to launch the file downloaded by the browser process; and notifying a user that a vulnerability of the browser may be exploited, if the determining result is positive.

### FIELD OF THE INVENTION

The present invention relates to a computer protection method and apparatus, and more particularly, to a method and apparatus for preventing a vulnerability of a web browser from being exploited by malware.

### BACKGROUND

Now, the vast prevalence of social and home network applications makes it possible for people to enjoy convenience and rapidness brought by the broadband network. Meanwhile, however, it also facilitates various viruses threatening computer security seriously such that a large number of viruses which make an attack via the network emerge.

Among various viruses which make an attack via the network, Trojans have become one type of favorite backdoor tools for hackers, because they are capable of sending specified information to a remote computer hiddenly at any time and even have the ability of remote interaction. However, Trojans do tremendous harm to users. Trojans may expose the computer of a user to the control and monitoring of the hackers, such that the hackers can steal information of the user remotely, such as the user's account information, password and the like, which is a serious threat to the security of the computer used by the user.

Up to now, Trojans have evolved into a variety of modes for embedding and loading, such that it is almost impossible for the user to guard against them. For example, one of the modes, which is called “Trojan-hosted”, intrudes into a website using vulnerabilities, and then embeds the program code of a Trojan into, e.g., a hyperlink on a webpage. Thus, the user might click the hyperlink embedded with the Trojan during browsing the webpage using a web browser, and thus install a virus on his computer automatically. Moreover, there is not any prompt when such a virus is installed automatically, so the computer is infected by the virus in an unperceivable manner.

Such a vulnerability attack mode as “Trojan-hosted” can not be solved thoroughly by the traditional virus-scanning and anti-virus software and computer protection software. The traditional computer protection methods are helpless for network attacks which exploit vulnerabilities, because they are all implemented by scanning virus signatures.

Therefore, there is an urgent need for a computer protection method to prevent a vulnerability of a web browser from being exploited to execute malicious code.

### SUMMARY

One of the objects of the present invention is to provide a method and apparatus for preventing a vulnerability of a web browser from being exploited. With the method and apparatus in accordance with the present invention, the behavior of automatically downloading and launching malware using a browser may be recognized, such that a vulnerability of the browser is prevented from being exploited to execute malicious code to infringe a user's computer.

In order to implement the object described above, the method for preventing a vulnerability of a web browser from being exploited in accordance with the present invention comprises: monitoring a file downloaded by a browser process; intercepting a process creating action initiated by the browser process; determining whether the intercepted process creating action is to launch the file downloaded by the browser process; and notifying a user that a vulnerability of the browser may be exploited, if the determining result is positive. In addition, a computer protection apparatus corresponding to the above method is also provided in the present invention.

According to the method of the present invention, before the browser process launches a program, the determination is made and the user is prompted that “the program to be launched is the file downloaded by the browser process”, thus the running of an untrusted program can be blocked timely, thereby preventing virus software downloaded through the browser from infecting the computer.

### BRIEF DESCRIPTION OF THE DRAWINGS

FIG. 1 illustrates an overall flowchart of a method for preventing a vulnerability of a web browser from being exploited in accordance with one embodiment of the present invention;

FIG. 2 illustrates a procedure of monitoring a file downloaded by the web browser in accordance with one embodiment of the present invention; and

FIG. 3 illustrates a procedure of intercepting a process creating action of the web browser in accordance with one embodiment of the present invention.

### DETAILED DESCRIPTION

A method and apparatus for preventing a vulnerability of a web browser from being exploited in accordance with the prevent invention will be described in detail in conjunction with some specific embodiments. For the purpose of disclosure, the following embodiments are described by taking only the Windows operating system as an example. However, it may be appreciated by those skilled in the art that the concept and spirit of the present invention may be applicable to other computer operating systems, and is not limited to the Windows operating system. In addition, for the purpose of description, “web browser” is referred to as “browser” hereinafter, so a browser herein means a web browser for browsing webpages.

As described above, when browsing a “Trojan-hosted” webpage using the browser, the user possibly downloads and installs unintentionally malware or viruses through the browser. In order to prevent effectively the browser from being exploited in this manner, the approaches usually used by such vulnerability exploiting programs are analyzed first.

Generally speaking, hackers will write shellcode when attacking a network using a vulnerability. Shellcode is a piece of code to be sent to a server in order to utilize a specific vulnerability. Shellcode may overwrite the original correct code in a memory and obtain execution privilege, thereby exploiting the vulnerability successfully to implement its own functions.

Specifically, the vulnerability exploiting programs usually adopt the following three modes:

1) Implementing all the functions in shellcode.

Some vulnerability exploiters will choose to implement all the functions of a virus in shellcode. However, usually shellcode is used to implement only relatively simple functions, because it is very difficult to write shellcode and the environment thereof is limited. Therefore, such a mode is not common. If the hackers want to implement complicated functions, they can only implement them by the following two modes.

2) Using shellcode to download a virus and execute it directly.

These vulnerability exploiters generally write a piece of simple shellcode to download malware, and then to call a function for launching a process, e.g., the API function such as WinExec, CreateProcess, or the like, so as to activate the malware. Such a mode is relatively common, and the vulnerability exploiters only need to replace different malware to implement different attack requirements.

3) Using shellcode to download a virus and execute it indirectly.

These vulnerability exploiters usually write a piece of simple shellcode to download malware and generate a script file, and to run the script file by calling other script interpreters, so as to activate the malware. This mode is as popular as the second mode, because the vulnerability exploiters only need to replace different malware to implement different attack requirements.

It can be seen from the analysis of the behavior of the vulnerability exploiting programs that: after a vulnerability is exploited successfully, i.e., certain malware is downloaded successfully, each of the vulnerability exploiting programs would either launch the malware directly by creating a process, or launch the malware indirectly by creating a interpreter to interpret and execute a script. Thus, for these types of vulnerability exploiting modes, the behavior of executing malicious code by a vulnerability exploiting program can be blocked by intercepting a process creating action of a browser process and then determining whether the program to be launched is the file downloaded by the browser.

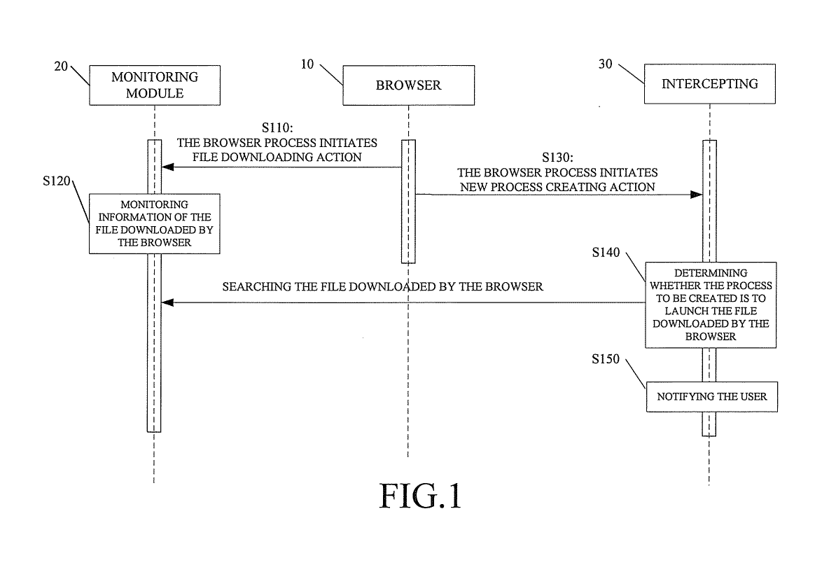

FIG. 1 illustrates an overall flowchart of a method for preventing a vulnerability of a browser from being exploited in accordance with one embodiment of the present invention.

As shown in FIG. 1, according to the concept of the present invention, in order to monitor a file downloaded by a browser process 10, a monitoring module 20 is added in one embodiment of the present invention. The monitoring module 20 will monitor and record the files downloaded by the browser process 10 from the beginning of the creation of the browser process 10. Meanwhile, in order to intercept a process creating action of the browser process 10, an intercepting module 30 is added. It should be noted that unless otherwise stated, the monitored browser process and the intercepted browser process herein refer to the same browser process, which is labeled as browser 10 in the figures.

In FIG. 1, whenever the browser process 10 initiates a file downloading action (step S110), the monitoring module 20 intercepts this action while recording information of the file downloaded by the browser process 10 (step S120). Then, according to the analysis of the vulnerability exploiting programs, the browser process 10 will attempt to create a new process to execute malicious code after the file has been downloaded. The role of the intercepting module 30 is to intercept such a process creating action (step S130), and then to search file information recorded by the monitoring module 20 to determine whether the process creating action is to launch the file downloaded by the browser process 10 (step S140). Finally, based on the determining result at the step S140, the intercepting module 30 determines whether to notify a user, so that the user could choose whether to reject creation of the process (step S150).

With the procedure as illustrated in FIG. 1, before a virus is installed or launched, the user may obtain information regarding the behavior of the suspicious program, and may then choose to permit or reject the execution of the suspicious program as needed. Therefore, if the intercepted program is a virus or Trojan, then it can be timely blocked from running, thereby avoiding infecting the computer.

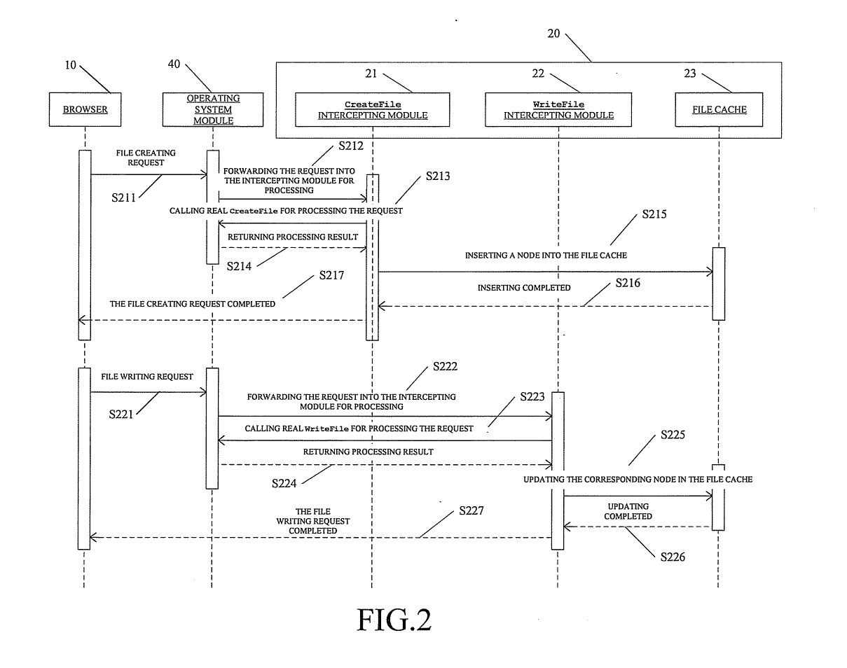

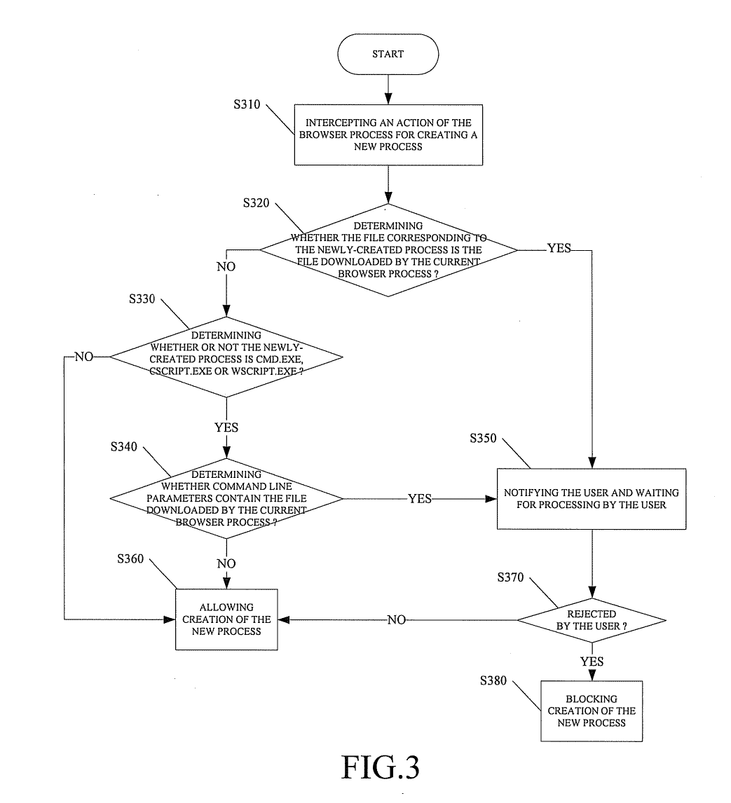

Specific operating procedures of the monitoring module 20 and the intercepting module 30 will be described in detail in conjunction with FIG. 2 and FIG. 3.

FIG. 2 illustrates the intercepting and monitoring action executed by the monitoring module 20 when shellcode attempts to download a file through the browser 10, after a vulnerability of the browser is exploited. As is well known in the art, a file downloading action may be divided particularly into a file creating action and a file writing action. In this connection, the monitoring module 20 includes a CreateFile intercepting module 21 configured to intercept the file creating action, a WriteFile intercepting module 22 configured to intercept the file writing action, and a file cache manager 23 configured to record information of the created or written file.

As shown in FIG. 2, when shellcode attempts to download a file, it first issues a file creating request to an operating system 40 (step S211). At this point, the CreateFile intercepting module 21 intercepts an action of the operating system 40 to create a new file or open an existing file, thus the file creating request is forwarded to the CreateFile intercepting module 21 in accordance with the present invention (step S212). The CreateFile intercepting module 21 then completes the file creating action by calling a real system file creating operation, such as the API function CreateFile( ) (step S213). If the creating action is successful, the CreateFile intercepting module 21 obtains a creating success message from the operating system (step S214). At this point, the CreateFile intercepting module 21 informs the file cache manager 23 so that the latter could record information of the file (step S215), and then a recording completion message is returned (step S216). Finally, the CreateFile intercepting module 21 returns a file creating request completing message to the browser process 10, after the recording of the file information is completed (step S217).

The file cache manager 23 shown in FIG. 2 is configured to record information of the files downloaded by the browser process. Since file operations of the browser are frequent, the file cache manager 23 can complete quickly the recording of the file information without affecting the usage for the user, only when satisfying requirements of quick search. Therefore, in the present invention, in order to implement quick search, the file cache manager maintains a red-black tree internally to manage the recorded file information. Of course, the present invention is not limited in this regard, and other data structures may be used instead. Each node on the red-black tree is used to record information of a created file as well as a flag (which will be updated in the file writing action) indicating whether the file is rewritten. Whenever the file cache manager is informed that the browser process creates or opens a file, it inserts a file description node into the maintained red-black tree, as shown in step S215, and then returns if the insertion is successful. Furthermore, in order to simplify the recorded information, in this embodiment, the file information that the file cache manager stores is only a check value of the file name/path, although the present invention is not limited to this.

After the information of the created file is recorded in the file cache manager successfully, as shown in FIG. 2, the vulnerability exploiting program begins to download malware, that is, issues a series of file writing requests to the operating systems 40 (step S221). In this embodiment, a file writing action of the operating system 40 is intercepted, thus the file writing request is forwarded to the WriteFile intercepting module 22 in accordance with the present invention (step S222). The WriteFile intercepting module 22 then completes the file writing action by calling a real system file writing operation, such as the API function WriteFile( ) (step S223). If the writing action is successful, the operating system returns a success message (step S224). After the file is written successfully, the WriteFile intercepting module 22 informs the file cache manager so that the latter could mark the file as rewritten in the file description node corresponding to the written file (step S225). The file cache manager returns an updating completion message after the rewriting flag is updated (step S226). Finally, the WriteFile intercepting module returns a file writing request completing message to the browser process 10 (step S227).

Thus, after the file creating and file writing actions are performed in turn by the vulnerability exploiting program through the current browser process, the file cache manager 23 not only records information of the corresponding file, but also marks the file as rewritten. Hence, the monitoring module 20 continues running, to monitor and record information of all the files downloaded by the browser process 10. The recorded file information may be used by the intercepting module 30. Since a red-black tree is maintained in the file cache manager, when querying whether a file is downloaded by the browser, the intercepting module 30 may search the red-black tree for a corresponding file description node and check its rewriting flag. If the corresponding node is found and its rewriting flag indicates that the file has been written, then it is indicated that the file is downloaded by the current browser process.

As described above, after the vulnerability exploiting program downloads the malware through the current browser process, it will launch a new process by the process creating action, thereby activating the downloaded malware.

In order to intercept the process creating action of the vulnerability exploiting program effectively, approaches used by shellcode writers to create a process should be analyzed first:

i. Using the API function CreateProcessA or CreateProcessW

Both of the functions are derived from kernel32.dll. This is a common approach for process creating.

ii. Using the API function ShellExecuteA or ShellExecuteW

The ShellExecute function will call the CreateProcess function finally, so its operation may be regarded as the same as that of the CreateProcess function and is unnecessary to be processed specially.

iii. Using the API function execvp/execve

These functions will also call the CreateProcess function finally, so they are unnecessary to be processed specially.

iv. Using the API function WinExec

The function is derived from kernel32.dll. The function is quite special, since it will not call CresteProcess or even ZwCreateProcess to create a process. Thus, the function must be intercepted separately herein.

v. Using the API function ZwCreateProcess

As is well known to those skilled in the art, the ZwCreateProcess function creates only a process object instead of a thread, so program code which calls this function must complete a series of operations, such as opening a file, creating a Section object, creating a process object, creating a thread, creating and launching a thread, and etc., in order to create a process really. Since there are some limitations in writing shellcode, writers of the vulnerability exploiting programs usually will not choose such an approach to create a process.

It can be seen apparently from the above analysis that only three API functions, i.e., CreateProcessA, CreateProcessW and WinExec, should be processed separately for intercepting of process creating.

Here, in order to facilitate intercepting and processing of these API functions, the respective characteristics of parameters of different API functions are neglected temporarily, and only their common characteristic is studied. It can be found through the study that no matter which approach is used to launch the process, a complete command line is required at the time of launching, which is their common characteristic. This command line contains necessarily information of a file to be launched, such as file name, path, and etc. Thus, obtaining information of the file to be launched can be achieved by analyzing the command line.

Based on the above analysis, the intercepting module 30 in accordance with the embodiment of the present invention will perform intercepting and processing, as shown in FIG. 3.

As shown in FIG. 3, a process creating intercepting module in the intercepting module 30 first intercepts an action of a certain browser process Pa for creating a new process Pb, by intercepting one or more of the three API functions, CreateProcessA, CreateProcessW and WinExec (step S310).

Then, a determining module in the intercepting module 30 obtains information of a file corresponding to a newly-created process, such as file name and path, which is obtained from parameters of the intercepted functions. After obtaining the file information, the determining module searches information of the files downloaded by the current browser process Pa, which is recorded by the monitoring module 10, that is, to search the red-black tree maintained in the file cache manager using the obtained file information in order to determine whether the file corresponding to the new process Pb is the file downloaded by the current browser process (step S320).

If the determining result at the step S320 is YES, that is, a corresponding file description node is found in the red-black tree maintained in the file cache manager and the flag of this node indicates that the file has been rewritten, then a notifying module in the intercepting module 30 sends a prompt message to the user to warn him that a vulnerability of the current browser process is possibly exploited, and then waiting for the processing by the user (step S350).

If the determining result at the step S320 is NO, then the determining module further judges whether or not the file corresponding to the newly-created process Pb is a command line program (e.g., cmd.exe) or a script interpreter, such as a command line script interpreter cscript.exe or a Windows script interpreter wscript.exe contained the Windows operating system (step S330). However, the present invention is not limited in this regard, and other script interpreters, such as perl, python, ruby, and the like, are also possible. If the judging result at the step S330 is NO, then it may be considered that the currently-created new process is safe, allowing it to continue running (step S360). Otherwise, the determining module will consider that the currently-launched new process is possibly to interpret and execute malicious code downloaded by the browser process. Therefore, the determining module further determines whether command line parameters of the command line program or script interpreter to be launched contain the file downloaded by the current browser process (step S340). Specifically, in this embodiment, the command line parameters of the above-described programs, such as cmd.exe, cscript.exe or wcscript.ext, are divided by the CommandLineToArgvW function, to obtain a number of parameters. Then, content of each parameter is checked in turn so as to determine whether the divided parameters contain the file downloaded by the browser and recorded by the monitoring module 20. If it is found that the file in the command line parameters is the file downloaded by the browser, then it is considered to be possible vulnerability exploiting and the user is notified (step S350). Otherwise, the creation of the new process is allowed (step S360).

Finally, at the step S350, the user is notified that a vulnerability of the current browser process may be exploited, and waiting for the processing by the user. If the user choose to reject process creating (step S370), then the process creating is blocked (step S380); otherwise, the process creating is allowed (step S360).

### Beneficial Effect

A method and apparatus for preventing a vulnerability of a web browser from being exploited in accordance with the present invention are described in conjunction with FIG. 1-3. With the method in accordance with the present invention, the running of those viruses downloaded through the browser may be blocked timely. Thus, the method and apparatus in accordance with the present invention can better solve the problem that a vulnerability of the web browser is exploited to execute malicious code. In addition, the method in accordance with the present invention allows a user to block timely those applets which are downloaded and installed automatically when browsing webpages, thereby avoiding occupation of computer resources.

Although the present invention is illustrated and described with regard to the preferred embodiments, it will be understood by those skilled in the art that many variations and modifications may be made without departing from the spirit and scope of the present invention defined by the following claims.

What is claimed is:

1. A method for preventing a vulnerability of a web browser from being exploited, comprising:
monitoring a file downloaded by a browser process;
intercepting a process creating action initiated by the browser process;
determining whether the intercepted process creating action is to launch the file downloaded by the browser process; and
notifying a user that a vulnerability of the browser may be exploited, if the determining result is positive.

2. The method according to claim 1, wherein the step of monitoring the file downloaded by the browser process comprises:
intercepting a file creating action of the browser process; and
intercepting a file writing action of the browser process.

3. The method according to claim 2, wherein the step of monitoring the file downloaded by the browser process further comprises:
storing information of the file created by the browser process in a file cache, based on the intercepted file creating request; and
storing a rewriting flag of the file created by the browser process in the file cache, based on the intercepted file writing request.

4. The method according to claim 3, wherein a data structure for user high-speed retrieval is maintained in the file cache, each node in the data structure recording information of one stored file and a corresponding rewriting flag.

5. The method according to claim 4, wherein whether the file to be launched is the file downloaded by the browser process is determined by searching the data structure for information of a corresponding node and checking the rewriting flag thereof.

6. The method according to any one of claims 1-5, wherein the determining step is to determine whether a program file corresponding to the created process is the file downloaded by the browser process.

7. The method according to any one of claims 1-5, wherein if the program file corresponding to the created process is not the file downloaded by the browser process, the determining step further comprises:
judging whether or not the program file corresponding to the created process is a command line program or a script interpreter; and
determining whether command line parameters of the command line program or the script interpreter contain the file downloaded by the browser process, if the judging result is positive.

8. The method according to claim 7, wherein the script interpreter includes at least one of a command line script interpreter and a Windows script interpreter.

9. The method according to claim 1, wherein the process creating action is intercepted by intercepting at least one of the three API functions, CreateProcessA, CreateProcessW and WinExec.

10. The method according to claim 3, wherein the information of the file stored in the file cache is a check value of the file name of the file.

11. The method according to claim 4 or 5, wherein the data structure is a red-black tree.

12. An apparatus for preventing a vulnerability of a web browser from being exploited, comprising an intercepting module and a monitoring module configured to monitor a file downloaded by a browser process, wherein the intercepting module comprises:
a process creating intercepting module configured to intercept a process creating action initiated by the browser process;
a determining module configured to determine whether the process creating action intercepted by the intercepting module is to launch the file downloaded by the browser process and monitored by the monitoring module; and
a notifying module configured to notify a user that a vulnerability of the browser may be exploited, if the determining result of the determining module is positive.

13. The apparatus according to claim 12, wherein the monitoring module comprises:
a file creating intercepting module configured to intercept a file creating action of the browser process; and
a file writing intercepting module configured to intercept a file writing action of the browser process.

14. The apparatus according to claim 13, wherein the monitoring module further comprises a file cache, wherein the file cache is configured to store information of the file created by the browser process, in response to a file creating request intercepted by the file creating intercepting module, and to store a rewriting flag of the file created by the browser process, in response to a file writing request intercepted by the file writing intercepting module.

15. The apparatus according to any one of claims 12-14, wherein the determining module is to determine whether a program file corresponding to the created process is the file downloaded by the browser process.

16. The apparatus according to any one of claims 12-14, wherein the determining module further comprises:
a module for judging whether or not a program file corresponding to the created process is a command line program or a script interpreter; and
a module for determining whether command line parameters of the command line program or the script interpreter contain the file downloaded by the browser process.
